(19) United States
(12) Patent Application Publication
(10) Pub. No.: US 2003/0222076 A1
(43) Pub. Date: Dec. 4, 2003

(54) Device for detecting a condition at a plate or wall of a domestic appliance

(76) Inventors: Erwin Potthof, Rothenbach (DE); Gerhard Lindner, Coburg (DE); Irene Jacob, Coburg (DE)

Correspondence Address: LERNER AND GREENBERTG, P.A., POST OFFICE BOX 2480, HOLLYWOOD, FL, 33022-2480, US

(21) Appl. No.: 10/408,808

(22) Filed: Apr. 7, 2003

(30) Foreign Application Priority Data
Apr. 5, 2002 (DE) 102 15 043.4

(51) Int. Cl. H05B 1/02

(52) U.S. Cl. 219/490; 219/509

(57) ABSTRACT

A device for detecting a condition at a plate or a wall of a domestic appliance, in particular a kitchen appliance, simplifies and improves condition detection. A sound wave transmitter disposed at least at one first location of the plate or the wall transmits sound waves onto the plate or the wall. A sound wave receiver or a sound wave-reflecting element is disposed at a second location of the plate or the wall remote from the sound wave transmitter. At least one parameter of the sound waves is influenced by a condition prevailing between the first location and the second location. An evaluation circuit evaluates the condition-governed influencing of the sound waves.

### BACKGROUND OF THE INVENTION

1. Field of the Invention

The invention relates to a device for detecting a condition at a plate or wall of a domestic appliance, in particular a kitchen appliance, especially a kitchen stove.

It is advantageous to detect the temperature of a material being cooked on hot-plates or cooktops of a kitchen stove or cooker without having to introduce temperature sensors into the material being cooked. In conventional individual cooktops of cast iron, a centrally disposed temperature measurement unit is provided, against which the bottom of the cooking pot bears. That structure is not a practicable one for glass ceramic cool top platforms or cooking hobs since it would require openings through the glass ceramic plate. Such openings can only be produced and sealed with difficulty, in terms of the production engineering involved. In addition, they would adversely affect the ease of care which is very important in regard to glass ceramic plates.

An infrared measurement device which senses the surface of the cooking pot is also known for detecting the temperature of the material being cooked. In that case, particular structural configurations for the cooking pot are required in order to achieve a suitable emission factor for temperature measurement.

In the case of glass ceramic plates, it is known to print electrical conductors onto the underside of the glass ceramic plate for temperature detection. It is possible to detect the temperature-dependent variation in electrical resistance of the glass ceramic material through the use of such conductors. Suitable materials for electrical conductor strips are difficult and complicated to apply and they are costly. It is also difficult to make contact between the conductor strips and electrical lines which extend therefrom. The conductor strips are exposed to direct heat from the respective heating configuration and they shade a part of the heat radiation which in itself is intended to impinge upon the bottom of the cooking pot. Since the glass ceramic becomes low in resistance upon being heated, the circuit of the conductor strips has to be separated from the electrical network.

In the case of ovens, it is known to place a temperature sensor in a corner of a wall of the oven. Such a sensor only detects the temperature at a point. It does not detect the temperature prevailing in the middle of the interior of the oven. Therefore, when developing the oven, time-consuming and cost-intensive tests have to be conducted in order to ascertain which temperature at the temperature sensor corresponds to which temperature in the interior of the oven. Such tests are also complicated and expensive in particular for the reason that the ratio between the temperatures is different for each kind of operation, such as top heating mode and/or bottom heating mode or hot-air operation. After the temperature ratios between the measurement location and the interior of the oven (temperature offset) have been ascertained, a mechanical regulator which is connected to the temperature sensor, for example a capillary tube sensor, has to be suitably adjusted in order to achieve a suitably good baking result in all operating modes. In practice it then often happens that the initially intended location for fitting the temperature sensor is unsuitable and has to be appropriately modified, after which all tests have to be carried out again.

### SUMMARY OF THE INVENTION

It is accordingly an object of the invention to provide a device for detecting a condition at a plate or wall of a domestic appliance, which overcomes the hereinafore-mentioned disadvantages of the heretofore-known devices of this general type, which provides for temperature detection of the kind set forth in the introduction hereto and with which temperature detection is simplified and improved.

With the foregoing and other objects in view there is provided, in accordance with the invention, a device for detecting a condition at a plate or a wall of a domestic appliance. The device comprises a sound wave transmitter disposed at least at one first location of the plate or the wall for transmitting sound waves onto the plate or the wall. A sound wave receiver or a sound wave-reflecting element is disposed at a second location on the plate or the wall remote from the sound wave transmitter. The first and second locations define a transmission path therebetween for the sound waves. The transmission path has a prevailing condition, and the sound waves have at least one parameter influenced by the prevailing condition. An evaluation circuit evaluates the influencing of the parameter of the sound waves by the prevailing condition to trigger at least one of a control procedure and a display.

The invention utilizes the realization that sound waves which are propagated in or on a transmission path of sound waves at a plate or wall are altered in dependence on a condition prevailing on the transmission path, in particular in regard to their propagation characteristic. Those alterations can be measured by measurement of a transit time of preferably pulsed signals, a phase shift, a change in amplitude or a resonance detuning. The detectable condition is in particular the temperature and/or an effect acting on the plate or wall, for example soiling, material being cooked which has run over, a break or a finger contact with the plate or wall. The device can be mounted to the plate or wall using simple measures. The region having a condition which is to be detected can be localized and delimited in a simple manner. The device can be embodied by using simple components.

The sound waves can be Rayleigh waves or Lamb waves. Those two types of waves differ with respect to their spatial propagation structure. Rayleigh waves are propagated on the surface. Lamb waves involve oscillations in the thickness of the plate or wall.

An advantage which is provided by the use of the device on cooktops for temperature detection is that temperature detection takes place very close to the bottom of the cooking pot. In addition, the device does not adversely affect the cooktop, special cooking pots are not required and the cooking zone does not suffer from any shading effect.

Regarding the use of the device in relation to ovens, it is desirable for the temperature to be detected in a large region of the wall. That makes it unnecessary to implement expensive and complicated adjustment procedures.

Heating elements and/or display elements of the appliance, in particular a cooking stove, can be controlled through the use of the device.

Preferably the evaluation circuit detects the phase shift or phase position of the sound waves, which changes in dependence on temperature. According to one embodiment of the invention, the sound waves are tuned to resonance, in which case the tuning goes off-tune in dependence on temperature. The evaluation circuit adjusts the sound wave frequency in such a way that the resonance condition is maintained. The magnitude of the frequency change which is necessary for that purpose corresponds to the respective change in temperature.

The evaluation circuit can also detect the change in the amplitude of the sound waves. It is possible in that way to recognize additional operating conditions.

Other features which are considered as characteristic for the invention are set forth in the appended claims.

Although the invention is illustrated and described herein as embodied in a device for detecting a condition at a plate or wall of a domestic appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, front-elevational view of a device according to the invention at a wall of an oven with a sound measurement path;

FIG. 2 is a side-elevational view of the wall and a block diagram of other elements of the device and of an appliance;

FIG. 3 is a front-elevational view of the wall with two sound measurement paths at different heights;

FIG. 4 is a front-elevational view of the wall as an alternative to the embodiment of FIG. 3;

FIG. 5 is a side-elevational view of a sound measurement device on a glass ceramic cooktop and a block diagram of other elements of the device and of an appliance;

FIG. 6 is a top-plan view of a glass ceramic cooktop with a central sound wave transmitter;

FIG. 7 is a top-plan view of a glass ceramic plate similar to FIG. 6; and

FIG. 8 is a top-plan view of a device according to the invention on a glass ceramic plate, at which four sound wave transmitters are provided.

### DESCRIPTION OF THE PREFERRED EMBODIMENTS

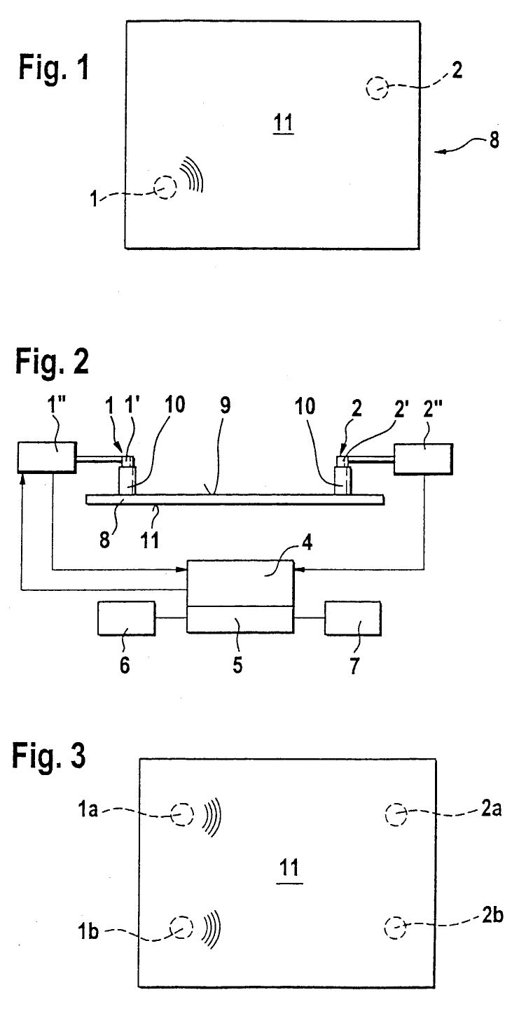

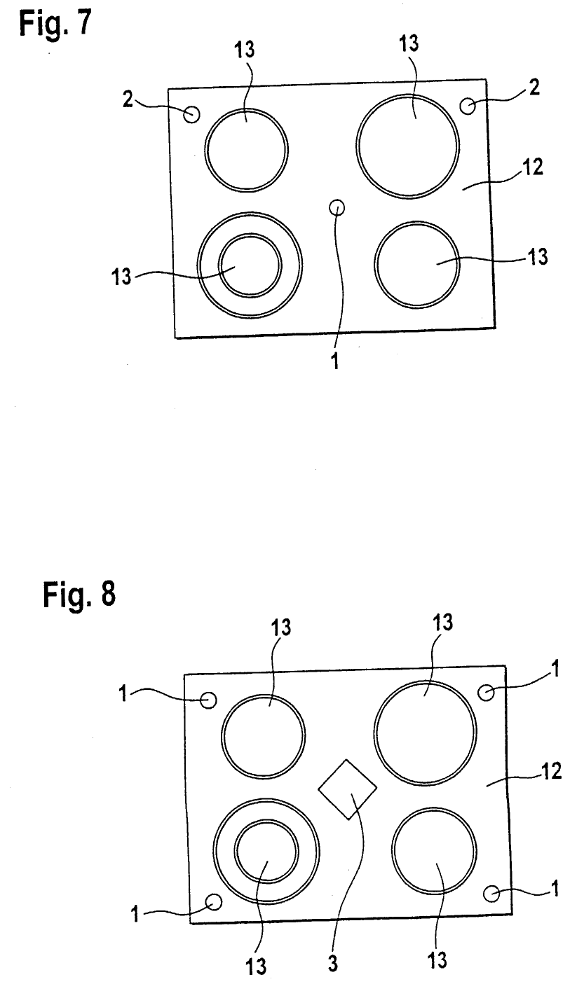

Referring now to the figures of the drawings in detail, it is seen that in the illustrated embodiments there is a measurement path between mutually spaced-apart first and second locations. There are two options provided for the respective measurement path. In the one case (see FIG. 1, FIG. 2, FIG. 3, FIG. 5, FIG. 6 and FIG. 7) a sound wave transmitter 1 is disposed at the first location and a sound wave receiver 2 is disposed at the second location. Both of these can operate with piezoelectric elements 1′, 2′ acting as the respective transmitting and receiving elements. A transmitting circuit 1″ is associated with the sound wave transmitter 1. A receiving circuit 2″ is associated with the sound wave receiver 2.

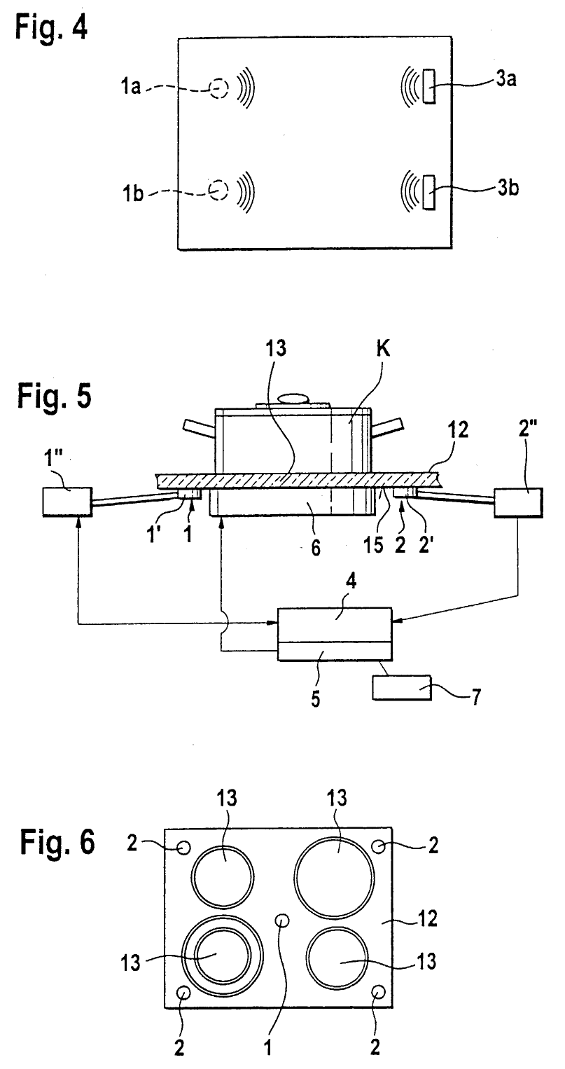

In the other case (see FIG. 4 and FIG. 8) a sound wave transmitter 1 which can be intermittently switched over from a transmission mode to a reception mode is disposed at the first location, and an element 3 reflecting sound waves is disposed at the second location. The sound wave-reflecting element 3 can be formed of a strip which is applied to the plate or wall, in particular by being printed thereon, and which forms a disturbance or interference location in such a way that sound waves impinging thereon are reflected. Such a defined interference location can also be formed by shaping the plate or wall out or in. Such an interference location is also formed by any break in the plate.

The working frequency of the sound wave transmitter 1 is, for example, about 1 MHz.

The sound waves from the sound wave transmitter 1 are propagated on or in the plate or wall. Therefore, the phase position of the sound waves changes in accordance with the respective temperature of the plate or wall, and the length of the measurement path.

In order to detect the variation in the phase position, the configuration has an electronic evaluation circuit 4 which compares the phase position of the transmitted sound waves to the phase position of the received sound waves and evaluates the resulting difference. The phase position difference forms a measurement with respect to the respective temperature or change in temperature. In regard to the evaluation procedure, it can also be provided for the system to be tuned to resonance and, upon temperature-governed detuning of resonance, for the sound wave frequency to be regulated back to the resonance condition. The magnitude of the change in frequency which is necessary in that case is a measurement with respect to the change in temperature.

A control circuit 5 is associated with the evaluation circuit 4. The control circuit 5 controls heating elements 6 and/or display elements 7 of the appliance (see FIGS. 2 and 5).

In the configuration shown in FIG. 1, the sound wave transmitter 1 is disposed in a downwardly disposed corner region of a baking oven wall 8 and the sound wave receiver 2 is disposed diagonally opposite in an upwardly disposed region of the oven wall 8. Both the transmitter and the receiver are fixed to the outside or outer surface 9 of the baking oven wall 8. In this case, the piezoelectric elements 1′, 2′ of the sound wave transmitter 1 and the sound wave receiver 2 are not fixed directly to the oven wall 8 but are joined thereto by way of spacer pieces 10. The piezoelectric elements are glued on the spacer pieces 10 and the spacer pieces 10 are connected to the oven wall 8. Preferably, the spacer pieces 10 are formed of a material which is a poor conductor of heat but which is acoustically hard or sound-reflecting, for example ceramic. The spacer pieces 10 serve to reduce the temperature at the piezoelectric elements to such an extent that a maximum permissible operating temperature thereof is not exceeded. An inside or inner surface 11 of the oven wall 8 delimits a baking space therein.

In the configuration shown in FIG. 1 the measurement path extends diagonally over the oven wall 8. That provides for the temperature to be detected in a large region of the oven wall 8 and not just at an individual location thereof. The temperature detected in that way forms a reliable measurement of the temperature which actually prevails in the interior of the oven. If necessary, the temperature can also be detected in the described manner at a plurality of walls, including at the bottom wall and the top wall, in which case the transmitter 1 can be disposed at one wall and the receiver 2 can be disposed at another wall.

In the embodiment shown in FIG. 3 an upper measurement path with a sound wave transmitter 1a and a sound wave receiver 2a and a lower measurement path with a sound wave transmitter 1b and a sound wave receiver 2b are provided at the oven wall 8. The upper measurement path detects top heat which prevails in the oven. The lower measurement path detects bottom heat which prevails in the oven. The distribution of top heat and bottom heat can be deliberately varied during the baking operation, according to the measurement result.

The embodiment of FIG. 4 corresponds to the embodiment of FIG. 3 in regard to detection of top heat and bottom heat. The embodiment of FIG. 4 does not have separate sound wave receivers. In place thereof sound wave-reflecting elements 3a, 3b are disposed on the oven wall 8 at the inside thereof. The sound wave transmitters 1a, 1b are intermittently switched over from the transmitting mode to the receiving mode, by way of the transmitter circuit. In that situation the respective sound wave transmitter 1a and 1b, in the receiving mode, evaluates the sound signal reflected by the respective sound wave-reflecting element 3a and 3b. That means that only one piezoelectric element per measurement path is required. The sound wave-reflecting element 3 can also be formed by an edge of the oven wall 8 itself.

It is possible for the transmission signals from the sound wave transmitters 1a and 1b to be unmistakably modulated, so that the configuration of FIG. 4 provides for the reflected signals to be evaluated only by the correct sound wave transmitter. That can be effected, for example, by pulse modulation. It is also possible for the sound wave transmitters 1a and 1b to be operated alternately. In that case, the sound wave transmitter 1a then operates neither in the transmitting mode nor in the receiving mode when the sound wave transmitter 1b is operating, and vice-versa.

The measurement path can also extend in two or more walls of the oven. For that purpose, the sound wave transmitter 1 is then disposed at one of the walls and the sound wave receiver 2 or the sound wave-reflecting element 3 is disposed at another oven wall 8.

FIGS. 5 to 8 show the device in relation to a glass ceramic plate 12 of a cool top platform or cooking hob which has a plurality of cooking zones 13. At least one heating element 6 for a cooking pot K is associated with each cooking zone 13. The sound wave transmitter 1 is disposed beside the cooking zone 13. The sound wave receiver 2 (see FIG. 5, FIG. 6 and FIG. 7) or a sound wave-reflecting element 3 or a plurality of sound wave-reflecting elements 3 (see FIG. 8) is or are disposed diagonally opposite beside the cooking zone 13. The temperature of the respective cooking zone 13 and therewith the temperature of the cooking pot K is detected in the measurement path which exists between the sound wave transmitters 1 and the sound wave receivers 2 or the sound wave transmitters 1 and the sound wave-reflecting elements 3. The phase position of the received sound waves changes according to the temperature of the cooking zone 13. As described, the phase position is compared, in which case the above-mentioned procedure involving resonance tuning and frequency adjustment can also be effected by way of the evaluation circuit 4 and the transmitter circuit. The electrical heating element 6 is controlled by the control circuit 5 according to the detected temperature.

In the embodiment shown in FIG. 6 a single sound wave transmitter 1 is provided in the center between four cooking zones 13. Sound wave receivers 2 are disposed opposite thereto in relation to each of the four cooking zones 13, in corner regions of the glass ceramic plate 12. The sound wave transmitter 1 and the sound wave receivers 2 are disposed at an underside or lower surface 15 of the glass ceramic plate 12 (see FIG. 5).

The embodiment of FIG. 7 is similar to that shown in FIG. 6. However, there are sound wave receivers 2 provided only in relation to two cooking zones 13 in FIG. 7.

In the embodiment shown in FIG. 8 four sound wave transmitters 1 which can each be switched over from the transmitting mode to the receiving mode are disposed in the corner regions of the glass ceramic plate 12 beside the cooking zones 13. Sound wave-reflecting elements 3 which are provided in the center of the glass ceramic plate 12 between the cooking zones 13 are disposed at the underside 15 of the glass ceramic plate 12. The sound wave-reflecting elements 3 respectively reflect sound waves emanating from the four sound wave transmitters 1 back to the latter. The sound wave-reflecting elements 3 can be formed by strips which are printed on to the top side of the glass ceramic plate 12. A single suitably configured, sound wave-reflecting element 3 can suffice for reflection of the sound waves of the four sound wave transmitters 1 back to the respective sound wave transmitter 1. The sound wave-reflecting element 3 or the sound wave-reflecting elements 3 can be formed of a hard ceramic which forms a sound wave-reflecting interference location at the top side of the glass ceramic plate 12.

In the described device it is also possible to compare the amplitude of the transmitted and received sound waves. The amplitude of the sound waves is damped, for example by material being cooked that has run over, or by contact with a switching zone. Events or conditions on the cooktop 12 can be evaluated by virtue of amplitude comparison and used for the control of functions of the appliance.

Various events can be recognized with the described device and suitably adapted functions of the appliance can be controlled in that way.

In order to ascertain the presence or the absence of a cooking pot, the evaluation circuit 4 can detect the speed of rise in the cooking zone temperature in relation to the heating power output set for a cooking zone 13 at the appliance. The speed of rise, that is the temperature gradient, is greater if there is no cooking pot standing on the cooking zone, than if a cooking pot is standing on the cooking zone. It is possible to switch off or reduce the heating output if there is no cooking pot standing on the cooking zone, by implementation of a suitable algorithm in the evaluation circuit 4 or the control circuit 5 which in practice are formed of a microprocessor or microcontroller. That avoids a dangerous operating condition.

In known systems for controlling the initial phase of cooking, a fixed time duration for the initial phase of cooking is associated with an adjustable cooking continuation output of the heating elements 6. For example, in the case of conventional kitchen stoves an initial cooking time of 4.8 min is fixedly associated with a cooking continuation stage “3” while an initial cooking duration of 6.5 min is fixedly associated in relation to a cooking continuation stage “4”. That rigid association presupposes that the user, on the basis of his or her experience, has picked out the correct setting values for a given combination of cooking pot and degree of filling thereof. With the device according to the invention it is possible to improve the initial cooking function insofar as the pattern of the rise in temperature of the respective cooking zone 13 is ascertained by evaluation of the sound signal.

The rise in temperature is ascertained by virtue of measurement of the rise in temperature upon manufacture of the appliance or when the appliance is first brought into operation, with a full feed of power to the heating elements 14 for each cooking zone 13, without a cooking pot. If then in the course of cooking a cooking pot with material to be cooked is put onto the cooking zone 13, the characteristic of the temperature variation becomes flatter than in the case of the initial measurement or in relation to the value stored therefrom. The required initial cooking heat requirement or initial cooking power output can be controlled in dependence on that difference.

The device can evaluate “trembling” of the sound signal amplitude, by way of the evaluation circuit 4. That effect occurs shortly before the material being cooked comes to boil. It is linked to the known generation of noise. In that situation sound waves are produced in the cooking pot. Those sound waves are superimposed on the sound waves of the plate or wall. That phenomenon can be detected by evaluation of the amplitude or frequency of the “trembling” of the received sound signal. In that way the initial cooking process can be set up as follows:

The initial cooking time is terminated at the latest when an initial cooking time duration fixedly associated with the respective cooking continuation stage is exceeded. The initial cooking time is ended prematurely when the value ascertained by the temperature rise gradient predetermines a shorter period of time. The initial cooking time is also ended prematurely when the signal ascertained from the “trembling” occurs prior to the other criteria.

It is also possible, through the use of the described device, to take the residual heat of the cooking zone 13 into account. Temperature measurement of the cooking zone 13 by way of the phase shift makes it possible, upon the input of a new setting parameter by the user, to control the energy which is still to be supplied, having regard to the heat content which still exists in the region of the cooking zone 13. In that case the initial cooking time can also be reduced by an amount which is dependent on the residual heat.

The device can also serve to detect when a cooking pan boils dry. When the liquid of the material being cooked in the cooking pan has evaporated there is a marked rise in temperature at the cooking zone 13. That can be evaluated for reducing or switching off the heating power output.

The described device is also suitable for detecting when material being cooked flows over out of the cooking pot on to the cooking zone 13. If material being cooked runs over on to the cooking zone the sound signal is damped in such a way that the sound signal amplitude is reduced. Thereupon the heating power is set back to a non-critical value or switched off, by way of the evaluation circuit 4 and the control circuit 5. It can be provided that, if thereafter cooling of the cooking zone 13 takes place, the heating element 14 is switched on again with the previous heating output or a reduced heating output in order to continue the cooking operation.

An electromechanical temperature limiter which is conventional in the state of the art and which protects the glass ceramic plate 12 from overheating may also be made unnecessary by virtue of the described device. The evaluation circuit 4 with the control circuit 5 is programmed for that purpose in such a way that the heating output is reduced or switched off before the critical glass ceramic temperature is reached.

An advantage of the described temperature measurement procedure is that the temperature which is critical for the glass ceramic plate 12 can be approached more closely than in the state of the art. Such a procedure thereby reduces the possible initial cooking time because it is possible to operate with a high level of heating output during the initial cooking time.

The described device also permits the following safety function:

Fires repeatedly occur in the operation of kitchen stoves because fat in the cooking pan becomes overheated and self-ignites. The flaming point of edible oils and edible fats is about 280° C. Self-igniting of edible oils and edible fats occurs at about 370° C. With the described device the temperature of the cooking zone 13 can be limited to a value below the self-ignition temperature of edible oils and edible fats. If the limit value is exceeded for a certain period of time then the heating output is switched off or at least reduced.

The described device is also suitable as a warning indication for hot cooking zones 13. It ascertains the warning signal from the phase shift of the sound waves.

It is desirable in regard to the described device and for the functioning thereof for the temperature of the glass ceramic to be measured on the surface of the glass ceramic plate 12 at the contact location with respect to the cooking pan or cooking pot K and for the temperature there to be evaluated for controlling the functions involved. The temperature of the glass ceramic plate 12 in the cooking zones 13 is detected more accurately than is the case in the state of the art by, virtue of temperature measurement by way of a sound signal.

It is also possible to initiate a safety shut-down procedure in the event of a breakage of the glass ceramic plate 12 by virtue of the described device because a breakage interrupts the transmission of sound. The evaluation circuit 4 and the control circuit 5 are programmable in such a way that either the cooking zone affected by the breakage or all of the cooking zones are shut down.

The display element 7 can provide necessary information about the settings and the operating condition, which is effected in the case of a microcontroller or microprocessor by way of interfaces. Such interfaces are in particular outputs:

for actuating signal devices,

for displaying the set reference temperature value of the cooking location,

for displaying the condition “initial cooking mode”,

for displaying the condition “safety limitation is active”,

for displaying the condition “reference temperature value is reached”,

for displaying the condition “residual heat level”,

outputs for the delivery of acoustic signaling with respect to the above-mentioned conditions,

outputs for the delivery of text information about the above-stated conditions, and

outputs for the delivery of speech information about the above-mentioned conditions, in particular speech delivery of the “careful-hot” information when a cooking zone is hot.

The sub-features described in relation to the above-discussed embodiments can also be used in others of the depicted embodiments. Depending on the respective conditions of use it is desirable for the individual features described hereinbefore with reference to FIGS. 1 to 8 to be respectively combined individually or in a multiple.

I claim:

1. A device for detecting a condition at a plate or a wall of a domestic appliance, comprising:
a sound wave transmitter disposed at least at one first location of the plate or the wall for transmitting sound waves onto the plate or the wall;
a sound wave receiver or a sound wave-reflecting element disposed at a second location on the plate or the wall remote from said sound wave transmitter;
said first and second locations defining a transmission path therebetween for the sound waves, said transmission path having a prevailing condition, and the sound waves having at least one parameter influenced by the prevailing condition; and
an evaluation circuit evaluating the influencing of the parameter of the sound waves by the prevailing condition to trigger at least one of a control procedure and a display.

2. The device according to claim 1, wherein the prevailing condition is temperature.

3. The device according to claim 1, wherein the prevailing condition is an effect acting on a surface of the plate or wall.

4. The device according to claim 1, wherein the parameter is selected from the group consisting of a transit time, a phase position, a resonance detuning, and an amplitude of sound wave signals.

5. The device according to claim 4, wherein the sound wave signals are pulsed.

6. The device according to claim 1, wherein said evaluation circuit controls at least one of:
at least one heating element and
at least one display element
of the domestic appliance.

7. The device according to claim 1, wherein the sound waves are tuned to resonance, the tuning is detuned in dependence on the prevailing condition, said evaluation circuit re-regulates a frequency of the sound waves to maintain a resonance condition, and a magnitude of the frequency regulation is evaluated as a measurement with respect to the prevailing condition.

8. The device according to claim 7, wherein the prevailing condition is temperature.

9. The device according to claim 1, wherein said sound wave transmitter is selectively intermittently switched over from a transmitting mode to a receiving mode, and said sound wave transmitter detects a sound wave signal coming from said sound wave-reflecting element in said receiving mode.

10. The device according to claim 1, wherein said sound wave transmitter is at least one sound wave transmitter disposed at the plate or wall, said sound wave receiver or sound wave-reflecting element is at least one sound wave receiver or sound wave-reflecting element disposed at the plate or wall, and a sound wave signal is modulated for detection of differing sound wave paths.

11. The device according to claim 1, wherein the wall is an oven wall and said sound wave transmitter and said sound wave receiver are disposed on an external surface of the oven wall.

12. The device according to claim 1, wherein the wall is an oven wall, said sound wave transmitter is disposed on an external surface of the oven wall and said sound wave-reflecting element is disposed on an inner surface of the oven wall.

13. The device according to claim 11, wherein said sound wave transmitter and said sound wave receiver are disposed at different levels on the oven wall.

14. The device according to claim 12, wherein said sound wave transmitter and said sound wave-reflecting element are disposed at different levels on the oven wall.

15. The device according to claim 11, which further comprises another sound wave transmitter, and another sound wave receiver, said sound wave transmitters and said sound wave receivers each being disposed at a respective upper and lower position on the oven wall for separately detecting top heat and bottom heat prevailing in an oven.

16. The device according to claim 12, which further comprises another sound wave transmitter, and another sound wave-reflecting element, said sound wave transmitters and said sound wave-reflecting elements each being disposed at a respective upper and lower position on the oven wall for separately detecting top heat and bottom heat prevailing in an oven.

17. The device according to claim 1, wherein the plate is a cooktop having a plurality of cooking zones, and said sound wave transmitter and said sound wave receiver are disposed at a bottom of the cooktop.

18. The device according to claim 1, wherein the plate is a cooktop having a plurality of cooking zones, and said sound wave transmitter is disposed at a bottom of the cooktop and said sound wave-reflecting element is disposed at a top of the cooktop.

19. The device according to claim 17, wherein the cooktop is a glass ceramic plate.

20. The device according to claim 18, wherein the cooktop is a glass ceramic plate.

21. The device according to claim 1, which further comprises another sound wave transmitter, and another sound wave receiver, the plate being a cooktop having a plurality of cooking zones, and said sound wave transmitters and said sound wave receivers being disposed at a bottom of the cooktop.

22. The device according to claim 1, which further comprises another sound wave transmitter, and another sound wave-reflecting element, the plate being a cooktop having a plurality of cooking zones, and said sound wave transmitters being disposed at a bottom of the cooktop and said sound wave-reflecting elements being disposed at a top of the cooktop.

23. The device according to claim 21, wherein the cooktop is a glass ceramic plate.

24. The device according to claim 22, wherein the cooktop is a glass ceramic plate.

25. The device according to claim 1, which further comprises another sound wave receiver, the plate being a cooktop having a plurality of cooking zones and corner regions, said sound wave transmitter being a common sound wave transmitter disposed centrally between the cooking zones, and said sound wave receivers being disposed in at least one of the corner regions, locating a respective cooking zone between said common sound wave transmitter and each of said sound wave receivers.

26. The device according to claim 1, which further comprises another sound wave-reflecting element, the plate being a cooktop having a plurality of cooking zones and corner regions, said sound wave transmitter being a common sound wave transmitter disposed centrally between the cooking zones, and said sound wave-reflecting elements being disposed in at least one of the corner regions, locating a respective cooking zone between said common sound wave transmitter and each of said sound wave-reflecting elements.

27. The device according to claim 1, which further comprises a least one other sound wave transmitter, the plate being a cooktop having a plurality of cooking zones and corner regions, said sound wave transmitters being disposed at least at two of the corner regions, and said sound wave receiver being at least one sound wave receiver disposed centrally between the cooking zones.

28. The device according to claim 1, which further comprises at least one other sound wave transmitter, the plate being a cooktop having a plurality of cooking zones and corner regions, said sound wave transmitters being disposed at least at two of the corner regions, and said sound wave-reflecting element being at least one sound wave-reflecting element disposed centrally between the cooking zones.

29. The device according to claim 1, wherein the plate is a cooktop having a plurality of cooking zones, and said evaluation circuit evaluates a speed of rise of a temperature of a cooking zone for at least one of:
detecting presence of a cooking pan;
detecting absence of a cooking pan;
detecting boiling dry of the cooking pan;
controlling initial cooking; and
controlling cooking continuation.

30. The device according to claim 1, wherein the plate is a cooktop having a plurality of cooking zones, and said evaluation circuit evaluates a temperature of a cooking zone for at least one of:
detecting heat;
reaching a temperature-limiting function;
reaching a safety temperature limitation; and
triggering a warning display when the cooking zone is hot.

31. The device according to claim 1, wherein at least one of said sound wave transmitter and said sound wave receiver has a piezoelectric element.

32. The device according to claim 1, wherein said sound wave-reflecting element is a layer applied to the plate or the wall.

33. The device according to claim 32, wherein said layer is printed on the plate or the wall.

34. The device according to claim 1, wherein said sound wave-reflecting element is an inwardly formed configuration of the plate or the wall.

35. The device according to claim 1, wherein said sound wave-reflecting element is an outwardly formed configuration of the plate or the wall.

36. The device according to claim 1, wherein said evaluation circuit evaluates a boiling process beginning in a cooking pan.

37. The device according to claim 1, wherein said evaluation circuit evaluates cooking material running over onto the plate.

38. The device according to claim 1, wherein said evaluation circuit evaluates breakage of the plate.

39. The device according to claim 1, wherein the domestic appliance is a kitchen appliance.

40. The device according to claim 1, wherein the domestic appliance is a kitchen stove.
